(19) United States
(12) Patent Application Publication
(10) Pub. No.: US 2011/0106558 A1
(43) Pub. Date: May 5, 2011

(54) INFECTION CONTROL SOLUTION

(75) Inventors: MELISSA J. SOLITO, Kansas City, MO (US); CAROL HUBER, Kansas City, MO (US); BRENT NIGHTINGALE, Kansas City, MO (US); HUGH RYAN, Lee's Summit, MO (US)

(73) Assignee: CERNER INNOVATION, INC., Overland Park, KS (US)

(21) Appl. No.: 12/610,732

(22) Filed: Nov. 2, 2009

(51) Int. Cl. G06Q 50/00; G06N 5/02; G06F 3/048

(52) U.S. Cl. 705/3; 706/54; 715/781

(57) ABSTRACT

Described herein are embodiments directed to electronically managing infections in healthcare facilities. A treating infection preventionist (“IP”) uses a remote computer to access patients assigned to the IP. A server analyzes healthcare data associated with patients and groups the patients into different infection control categories (“IC categories”) for treatment or further monitoring. The IP can view assigned patients by their IC categories, receive alerts for potentially dangerous conditions in patients, and access real-time patient records from a remote computer.

### BACKGROUND

Controlling the spread of infections in a healthcare facility is an enormous task. Healthcare professionals dedicated to the management of and prevention of infections in health care facilities are commonly referred to as infection perfectionists (“IPs”) and comprise nurses, physicians, epidemiologists, pharmacists, medical technologists, or other clinicians working to limit the spread of infections in a healthcare facility. The goal of an IP is to reduce the number of patients within a healthcare facility exposed to infections and thus reduce the patients contracting or spreading healthcare associated infections (“HAIs”), commonly called nosocomial infections, on tope of the ailments patients currently have. The spread of infection within a healthcare facility is a difficult task to manage, and if not handled properly, can be very expensive.

HAIs are infections that are a result of treatment in a hospital or healthcare facility, but are secondary to a patient's original condition. For example, a patient admitted to a hospital for a broken leg may contract influenza from a treating nurse who has the virus herself. HAIs typically appear within seventy-two hours after a patient is admitted or within thirty days after a patient is discharged. Common HAIs include, without limitation, staph infections, tuberculosis, pneumonia, urinary tract infections, influenza, and any virtually contractible infections. Most HAIs are not reimbursable by insurance providers, resulting in the healthcare facility responsible for a patient contracting an HAI to cover the expense of treating the HAI. As one may understand, such expenses can quickly rack up and become costly to the healthcare facility.

Ideally, there would be zero HAIs in a healthcare facility. In reality, though, HAIs are a real threat both to patients and to healthcare facilities' bottom lines. While HAIs may never be fully eliminated from the healthcare system, proper management of a facility can drastically reduce the spread and cost of HAIs. IPs need to analyze information about patients (e.g., age, gender, ailments, lab results, procedures, etc.) as well as information about the cleanliness of a healthcare facility treating the patients to quickly identify HAIs.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One aspect of the invention relates to organizing patients under the watch of IPs into different IC categories depending on the healthcare data for each patient. The IC categories may specify that a patient needs to be assessed for an infection, monitored further, or not at risk for spreading or contracting infections. Healthcare data is analyzed and compared against conditions for triggering events specified by either a healthcare facility or a medical organization. Patients are grouped into the IC categories based on the patents' healthcare data meeting the set conditions. Lists of an IP's patients are organized into an electronic document that filters the patients into appropriate IC categories, and the electronic document is sent to the IP to be viewed on a remote computer.

Another aspect of the invention relates to sending IPs alerts when patients need immediate care or a certain medical task should not be performed. To identify these alerts, patients' healthcare data is analyzed to for information that meets alert conditions set by the healthcare facility or medical association. Alerts can then be transmitted to an IP's remote computer for any potentially dangerous or exigent patient situation.

Another aspect of the invention relates to a graphic user interface (“GUI”) display that can be displayed on a computing device being used by an IP. A list of the IP's patients are presented in one display area, such that the patients are organized into IC categories depending on the patients' healthcare data. The IP may selectively view a patient's healthcare data, which is presented in a second display area. The displayed healthcare data may include various information, such as the lines and tubes used on the patient.

### BRIEF DESCRIPTION OF THE SEVERAL VIEWS OF THE DRAWINGS

The present invention is described in detail below with reference to the attached drawing figures, wherein:

FIG. 1 is a block diagram illustrating components of a system for use, according to an embodiment of the present invention;

FIG. 2 illustrates a networked computerized healthcare environment and a work flow for managing patient infection risks in a healthcare facility, according to an embodiment of the present invention;

FIG. 3 illustrates a flow chart for managing infections in a healthcare facility, according to an embodiment of the invention;

FIG. 4 illustrates a GUI showing patients of an IP grouped into different IC categories, according to an embodiment of the present invention;

FIG. 5 illustrates a GUI after an IP selects a patient in an IC category, according to an embodiment of the present invention;

FIG. 6 illustrates a GUI with additional patient healthcare data, according to an embodiment of the present invention;

FIG. 7 illustrates a GUI window with a display area for different orders assigned to a patient, according to an embodiment of the present invention; and

FIG. 8 illustrates an IC alert being presented to an IP, according to an embodiment of the present invention.

### DETAILED DESCRIPTION

The subject matter described herein is presented with specificity to meet statutory requirements. The description herein, however, is not intended to limit the scope of this patent. Instead, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

Embodiments described herein generally refer to computerized management of patients by IPs. An IP is provided with clinically relevant healthcare data about patients under the IP's care in real time or near-real time. Using a remote computer or handheld device, the IP can access a plethora of information about patients being treated in a healthcare facility and to quickly identify, diagnose, and manage HAIs or other infectious diseases threatening patients under the IP's care.

In one embodiment, patients under the IP's care are classified into different threat levels based on the risk each patient has for contracting an infectious disease. These threat levels are referred to as IC categories herein. For clarity, the terms “IC category,” “triggering event,” and “IC alert,” are discussed in further detail.

An IC category refers to a categorical bucket into which patients are classified depending on each patient's risk for contracting or spreading an infection disease. In one embodiment, IC categories convey to the IP which patients need to be monitored more closely, which patients need to be monitored less closely, and which patients need a medical assessment of from the IP. Classifying patients into IC categories may be done by an IP or software executing rules specified by a healthcare facility or medical organization (e.g., the Centers for Disease Control (“CDC”), American Medical Association (“AMA”)). Exemplary IC categories mentioned herein are called the “needs assessment,” “ongoing assessment,” and “low risk” categories. As referred to herein, the needs assessment IC category includes patients needing to be assessed by an IP. Ongoing assessment includes patients needing to be monitored in the future for infectious diseases. Low risk patients have been determined to pose little to no threat of contracting an infectious disease. Other categorical classifications are also possible and fully contemplated by embodiments of the invention. Grouping patients into different IC categories allows an IP to quickly be able to see which patients need to be assessed or monitored closely.

In one embodiment, patients are placed into different IC categories by software-based rules that analyze different healthcare data about the patients. For example, software may be configured to automatically place a patient who has received a lab result indicating a urinary tract infection (“UTI”) into the ongoing assessment category. Or in another example, a patient who had a high temperature but recently has a normal temperature may be placed from the ongoing assessment to the low risk category. Other such scenarios are also possible.

“Healthcare data” generally refers to information typically stored or recorded for a patient in a healthcare facility. Healthcare data may include myriad of information, such as, for example but without limitation, orders, tasks, vital signs, lab results, IP assessments, conditions, surgical history, lines, tubes, microbiology results, serology tests, medications, diet, diagnoses, diagnostic tests, blood stream infections (“BSIs”), ventilator assisted pneumonia (“CAP”), surgical site infections (“SSIs”), urinalyses, vital signs (e.g., temperature, blood pressure, heart rate, oxygen saturation, etc.), medications, reported problems (e.g., abdominal pain, bloody sputum, etc.), type of isolation (e.g., airborne, contact, droplet, etc.), microbiology (e.g., culture growth, no growth, etc.), healthcare facility location, wallet information (e.g., name, gender, date of birth, sex, race, etc.), genetics, inserted lines, tubes, vaccination records, diagnoses, admission dates, medical imaging, lab results, orders, tasks, vital signs, lab results, IP assessments, surgical history, serology tests, medications, diet, urinalyses, or any other healthcare information relevant to a patient in a healthcare facility. In one embodiment, patient healthcare data is analyzed by software to determine whether any combinations of data represent events that need additional care.

Triggering events refer to medical rules, codified in software, that determine the IC category a patient is classified into based on the patient's healthcare data or an IP's assessment. The medical rules of triggering events may be set by a treating healthcare facility through its administrators or by a medical association, like the CDC. When patient healthcare data meet the conditions of a triggering event, a patient will be classified into a specific IC category accordingly. In one embodiment, triggering events move a patient from one IC category to another without input from an attending IP. Alternatively, the IP may specify the IC category for a particular patient.

Numerous conditions may be used to justify a triggering event (i.e., placing a patient into another IC category). The following examples are provided for illustrative purposes, not to restrict embodiments to any particular conditions. A patient with a surgery in the last X days and has a positive wound culture for a particular bacteria. A patient who has line placed or has been intubated for Y number of hours and has a positive blood culture or a UTI. A patient who has been on a ventilator for a period of time and has a positive sputum culture collected within Y hours since being put on the ventilator. Again, these are merely examples, and additional conditions may also be used to justify triggering events.

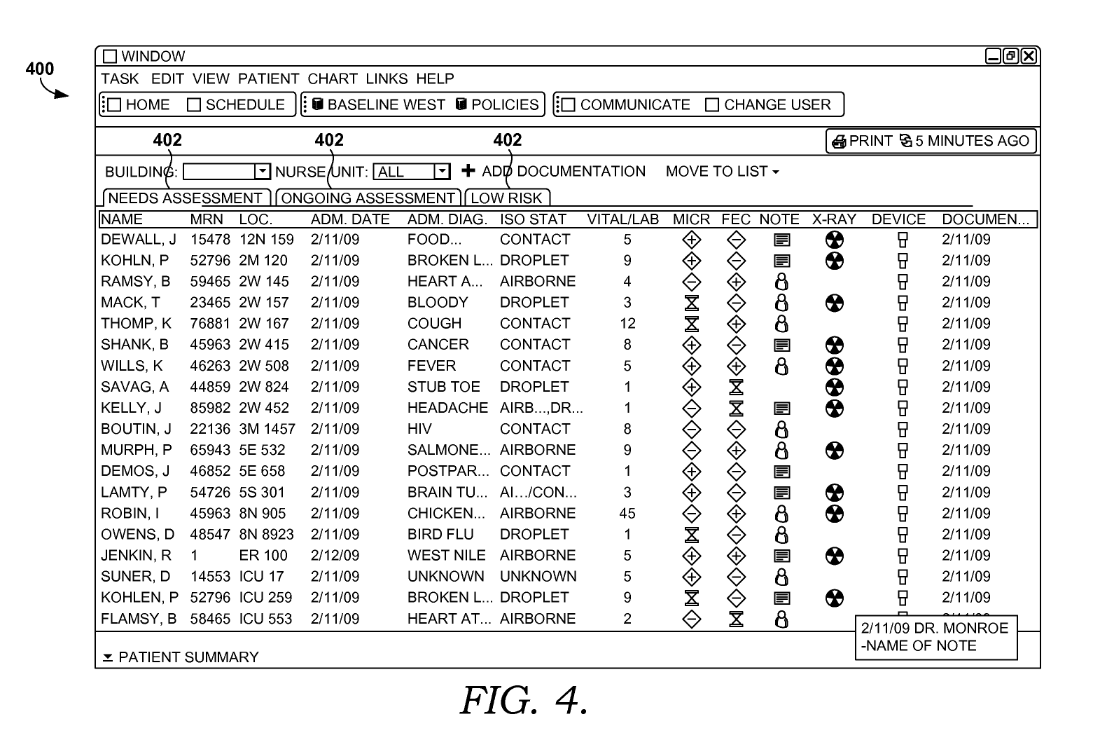

Triggering events may account for HAIs (or “nosocomial infections”), when such infections are detected in patients. When an HAI is detected in a patient, the patient may be moved into a different category, and an IP may be notified (on a remote computing device) that the patient has or potentially has an HAI. While not illustrated in the screen shots of FIGS. 4-8, in some embodiments, an IP may be presented with an indication of whether patients have HAIs or not.

With respect to HAI detection, software may take into account patient-specific data, patient-location data, treating-clinician data, or the like. Patient-specific data may include a patient's health care and personal information. For example, without limitation, the patient's health care and personal information may include indications of age, date of birth, gender, ethnicity, blood type, allergies, clinician orders, surgeries, medical histories, surgical histories, medical tests, results of medical tests, patient symptoms, addictions, diseases, viruses, evaluations of medical imaging. As one skilled in the art will understand, medical imaging may include various testing techniques capable of analyzing the patient's body as well as its function. Examples include, without limitation, X-Ray, magnetic resonance imaging (MRI), multimodal neuroimaging, anatomically constrained magnetoencephalography (aMEG), nuclear magnetic resonance (NMR), electroencephalogram (EEG), electrocardiogram (EKG), and ballistocardiogram.

Patient-location data refers to information about health care facilities, attending medical staff (including clinicians), and other patients. Examples include, without limitation, indications of recent outbreaks in a patient's hospital, room, or wing, as well as patient and clinician histories in health care rooms (e.g., the type of surgery previously performed in a surgery room). Patient-location data may also refer to the particular area of a hospital, such as an emergency room or burn center, where infections may spread more rapidly.

An IC alert is a notification sent to an attending IP for a given patient. The IC alert identifies an action, task, or order for the patient that needs to be administered. One example of an IC alert is an order for isolation (e.g., airborne, droplet, etc.). Much like triggering events, IC alerts may also be based on rules or conditions specified by a healthcare facility or medical association. Additionally, IC alerts may be based on the healthcare data of a patient. An IC alert may be generated when an IP attempts to order medication for a patient after the patient has a positive lab result for an ailment that is resistant to the medication. To illustrate, if an IP attempts to order ampicillin for a patient who recently had a culture found to contain streptococcus pyogenes, an IC alert may be generated to indicate streptococcus pyogenes is resistant to ampicillin. Additionally, a recommendation may be generated along with the IC alert for a medication not resistant to streptococcus pyogenes. IC alerts and recommendations are eventually presented to the IP or a physician or pharmacist on a remote computing device.

In one embodiment, triggering events and IC alerts are based on patient healthcare data. For instance, if a patient's vital signs suddenly fluctuate and the patient has an anomaly revealed in an x-ray, the vital signs and anomaly may meet the conditions of a triggering event and thus specify the patient should be placed into either the needs assessment or ongoing assessment IC category. In that context, an IC alert may be issued and sent to the IP treating the patient.

Various medical devices and healthcare data may be considered for conditions of triggering events and IC alerts. While not an exhaustive list, examples include: orders, tasks, vital signs, lab results, IP assessments, conditions, surgical history, lines, tubes, microbiology results, serology tests, medications, diet, diagnoses, diagnostic tests, blood stream infections (“BSIs”), ventilator assisted pneumonia (“CAP”), surgical site infections (“SSIs”), urinalyses, and so forth. In one embodiment, a particular line or tube (e.g., a catheter, intravenous (“IV”) line, central line, ventilator, etc.) as well as the date, time, or duration of the intubation may be considered. For example, a triggering event or IC alert may consider that a urinary catheter was inserted for X number of days and thus places the patient at risk for infection. Other examples of line insertion or intubation may alternatively be considered. Relative to the microbiology of a patient, growths found in a culture, cell irregularity found in biopsy or tissue samples, or such routine tests can be considered when evaluating triggering events and IC alerts.

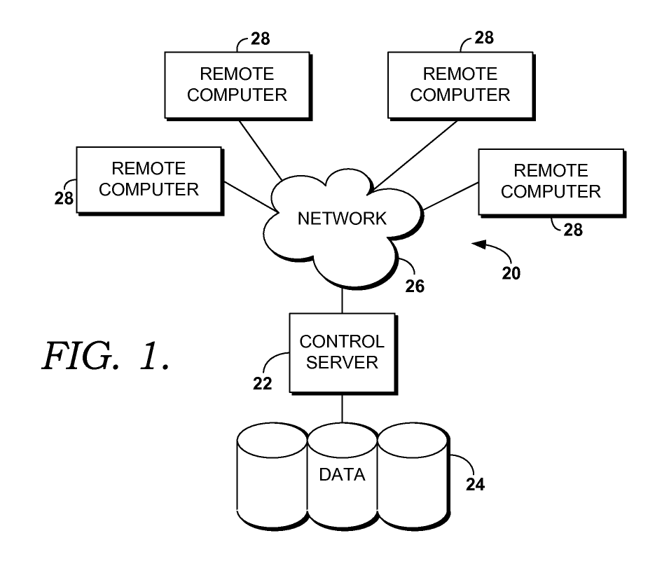

With reference to FIG. 1, an exemplary medical information system for implementing embodiments of the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus (also known as a Mezzanine bus).

Server 22 typically includes therein or has access to a variety of computer-readable media, for instance, database cluster 24. Computer-readable media can be any available media that can be accessed by server 22, and includes both volatile and nonvolatile media, removable and nonremovable media. By way of example, and not limitation, computer-readable media includes computer-storage media. Computer-storage media includes volatile and nonvolatile, removable and nonremovable media implemented in any method or technology for storage of information, such as computer-readable instructions, data structures, program modules or other data. Computer-storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22.

The computer-storage media, including database cluster 24, discussed above and illustrated in FIG. 1, provides storage of computer-readable instructions, data structures, program modules, and other data for server 22. Server 22 may operate in a computer network 26 using logical connections to one or more remote computers 28. Each remote computer 28 may be any well-known computing devices, such as, for example but without limitation, a computer, palm pilot, personal digital assistant (PDA), smartphone, BlackBerry®, or the like. Furthermore, remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home healthcare environment. Clinicians include, but are not limited to, the treating physician; specialists such as surgeons, radiologists and cardiologists; emergency medical technologists; discharge planners; care planners; physician's assistants; nurse preventionists; nurses; nurse's aides; pharmacists; dieticians; microbiologists; laboratory experts; laboratory scientists; laboratory technologists; genetic counselors; researchers; veterinarians; and the like.

The remote computers may also be physically located in nontraditional medical care environments so that the entire healthcare community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprisewide computer networks, intranets and the Internet. When utilized in a WAN networking environment, server 22 may include a modem or other means for establishing communications over the WAN, such as the Internet.

In a networked environment, program modules or portions thereof may be stored in server 22 or database cluster 24 or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention. Although the method and system are described as being implemented in a LAN operating system, one skilled in the art would recognize that the method and system can be implemented in any system.

In one embodiment, database cluster 24 is configured to store patient data. The lists of different types of patient data provided above are merely exemplary and are not meant to be exhaustive. Also, techniques for storing, organizing, and retrieving patient data in database cluster 24 are well-known to those skilled in the art, and need not be discussed at length herein.

In one embodiment, patient data may include an order, such as a request by a clinician for an action related to the patient. The action can be the initiation of a diagnostic test, the administration of a medication, a defined diet, or other healthcare-related action. Orders are captured by clinical information systems by a variety of means—direct user entry (computerized provider order entry (CPOE)), indirect entry by an intermediary, for example a verbal or written request that is conveyed to a nurse, the lab or pharmacy; or by an interface from another information system.

Orders can be placed singly or as a set. A single order would be ordering an individual medication or a serology test, while a set has multiple orders. An exemplary order set is a Chem 20, in which a number of discrete laboratory tests are ordered through a single action. Placing an order in the system has a variety of implications, including its formal presence in the clinical workflow and the triggering of billing-related events.

In one embodiment of the invention, an order within a set of orders can be designated as optional. Unlike conventional orders, optional orders are not placed in the system by default when the set of orders is placed. An optional order can be activated at the time the order set is placed or later in the process. If the user is ordering a set of orders associated with optional orders, the user is prompted to activate the optional orders. Optional orders that are selected are activated and added to the set of orders. Optional orders that were not activated when ordering the order set are displayed with the set of placed orders, allowing them to be activated later if necessary. A technologist or scientist can activate optional orders based on the findings associated with other orders in the case, allowing for flexibility of the testing path. In another embodiment, the ability to designate whether the activation of the order can occur at order time or only after the order sets have been placed is provided.

Although many other internal components of server 22, database cluster 24, and computers 28 are not shown, those of ordinary skill in the art will appreciate that such components and their interconnection are well known. Accordingly, additional details concerning the internal construction of server 22 and computer 28 need not be disclosed in connection with the present invention.

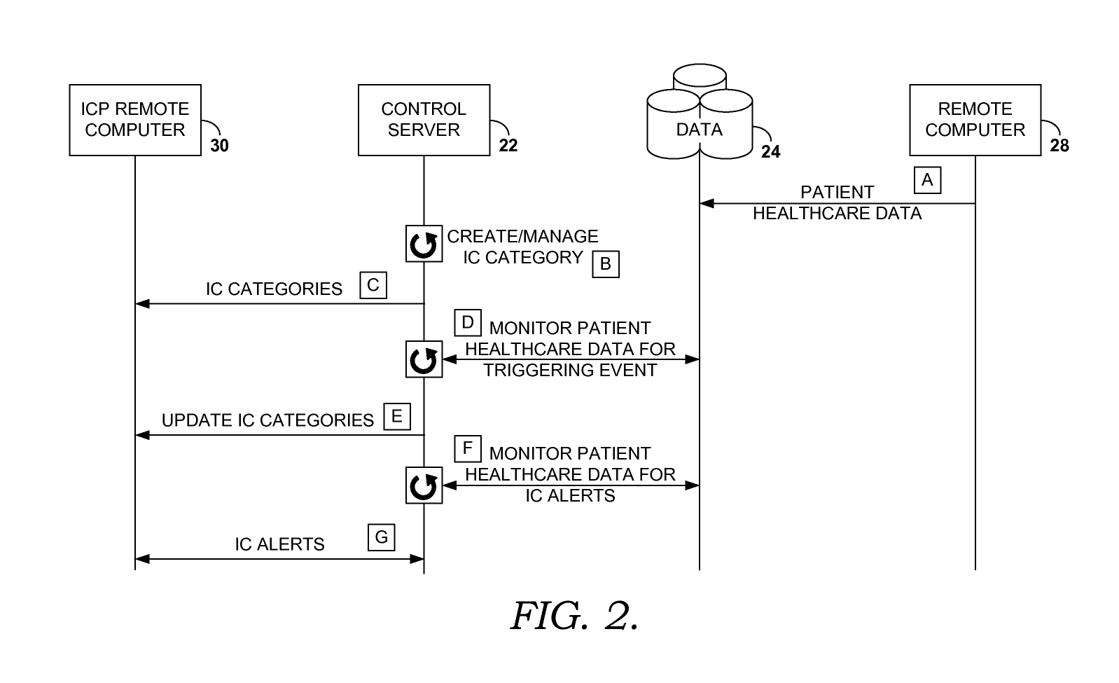

FIG. 2 illustrates a networked computerized healthcare environment and a work flow for managing patient infection risks in a healthcare facility, according to an embodiment of the present invention. As shown, a control server 22, database cluster 24, remote computer 28, and IP remote computer 30 operatively communicate with each other over a network. In particular, the remote computer 30 represents a computing device being viewed by an IP—such as a laptop, desktop, handheld device, PDA, or the like. The four devices shown communicate the IC categories of patients as well as IC alerts to IPs using the IP remote computer 30.

Healthcare professionals enter healthcare data about patients at the remote computers 28 and transmit the patient healthcare data to the database cluster 24, as shown at A. Entry of patient healthcare is an ongoing process, so the database cluster 24 may constantly be updated with new relevant information. In one embodiment, the control server 22 creates and manages IC categories by accessing the patient healthcare data in the database cluster 24, as shown at B. Managing IC categories may also be an ongoing and continuous process. New patient healthcare data may initiate conditions of triggering events being applied by the control server 22 to organize moving patients into different IC categories. For example, the control server—through software-based rules centered around triggering events—may determine that a patient with a particular result from a wound culture having had a particular surgery may be moved to the ongoing assessment IC category for monitoring. In another example, when a Foley catheter has been removed for longer than 48 hours during which a patient's vital signs have remained steady or a lab result has returned no indication of infection a triggering event may place, the patient into the low risk IC category.

The control server 22 monitors patient healthcare data stored in the database cluster 24 for triggering events, as specified by a healthcare facility or medical organization (as shown at D). IC categories are presented to the IPs as shown at C. Various patient healthcare data may be presented along with patients names so the IP can view information relevant for an IC assessment or monitoring the patients. In one embodiment, the various patient healthcare data is pulled from the database cluster 24 and presented in real time. For example, the IP may view patients in IC categories as well as the real-time vital signs, lab results, or other healthcare data for each patient.

Some embodiments may not provide patient healthcare data in real time but instead provide patient healthcare data retrieved or received at periodic intervals. In one embodiment, software scripts executing in applets on the IP remote computer or servlets on the control server 22 may be configured to periodically push, pull, or push/pull patient healthcare data. Alternatively, scripting software may allow the IP to request patient healthcare data from the database cluster 24.

Whenever a triggering event is determined, the control server 22, in one embodiment, updates a patient's IC category. If, for example, a patient was listed in the needs assessment IC category and an attending IP reviewed the patient's healthcare data and determined the patient was not at risk for contracting an infection, the IP could indicate on the IP remote computer 30 that the patient should be moved to the low risk IC category. As a result, the control server 22 updates the IC categories for the IP to indicate the patient is in the low risk IC category.

As shown at F, the control server 22, in one embodiment, monitors patient healthcare data in the database cluster 24 for IC alerts. When the control server 22 detects an IC alert should be issued, the control server 22 communicates the IC alert to the IP remote computer 30, as illustrated at G.

Although not shown in FIG. 2, patient lists may be presented on the IP remote computer 30 so a viewing IP can access additional healthcare data on each patient. In other words, embodiments may not only provide IPs with lists of patients. Instead, patients listed may be hyperlinked to additional patient healthcare data on the database cluster 24. To do so, the control server 22 may create patient lists using a mark-up language (e.g., hypertext mark-up language (“HTML”), extensible mark-up language (“XML”), or the like) that hyperlinks to underlying patient healthcare data. An attending IP may select a hyperlinked patient name on a list to access the patient's real time (or near real time) vitals, lab results, medications, microbiology, serology, lines and tubes, fecal analyses, surgical history, and so forth.

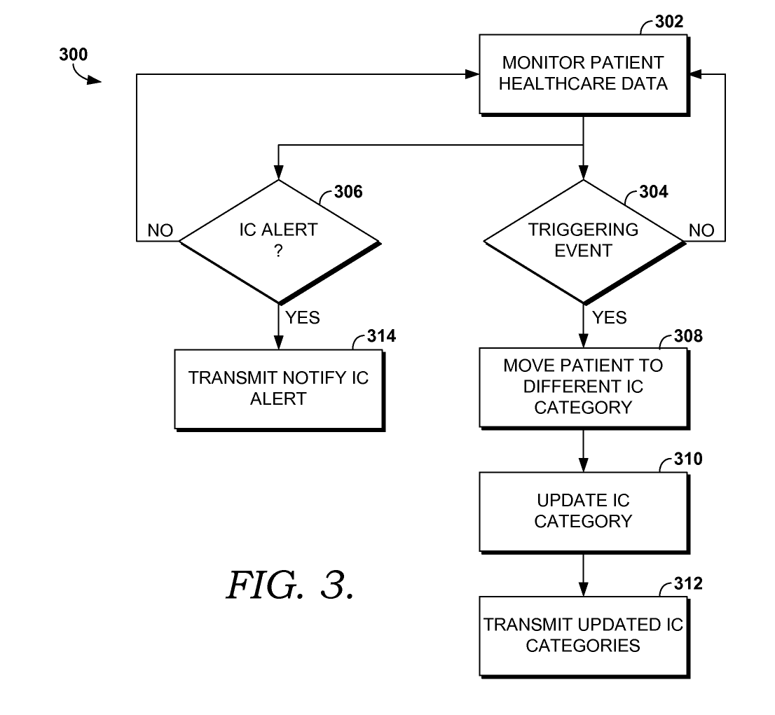

With reference to FIG. 3, a flow chart illustrating techniques for managing infections in a healthcare facility is shown, according to an embodiment of the invention. The steps shown are provided merely for illustrative purposes and do not necessarily restrict embodiments to any particular sequence of steps decisions.

Initially, patient healthcare data is monitored, as shown at 302. Specifically, the patient healthcare data is monitored to determine whether any triggering events have occurred (shown at 304) or IC alerts (shown at 306) should be generated. Doing so may require a control server to compare the patient healthcare data against different criteria specified by the healthcare facility or a medical organization. When a triggering event is detected for a patient, the patient is moved to a different IC category—e.g., from needs assessment to ongoing assessment or low risk—as shown at 308. After an IC category is updated (shown at 310), the updated IC category is transmitted (either immediately or subsequently) to an IP remote computer. Similarly, IC alerts, when detected, are transmitted to the IP remote computer. In this way, an attending IP can review the most updated IC categories assigned to the IP and receive IC alerts quickly.

To illustrate the patient lists presentable to IPs, several user interfaces are shown in FIGS. 4-10. Turning initially to FIG. 4, a GUI 400 showing patients of an IP grouped into different IC categories is shown, according to embodiment of the present invention. An IP's patients are grouped into IC categories 402. The IC categories 402 include patients needing evaluation by the IP (NEEDS ASSESSMENT), patients needing to be periodically monitored for infections (ONGOING ASSESSMENT), and patients posing less risk for infections (LOW RISK). The IP can select any of the IC category 402 tabs to review the patients assigned to the IP in the different IC categories 402.

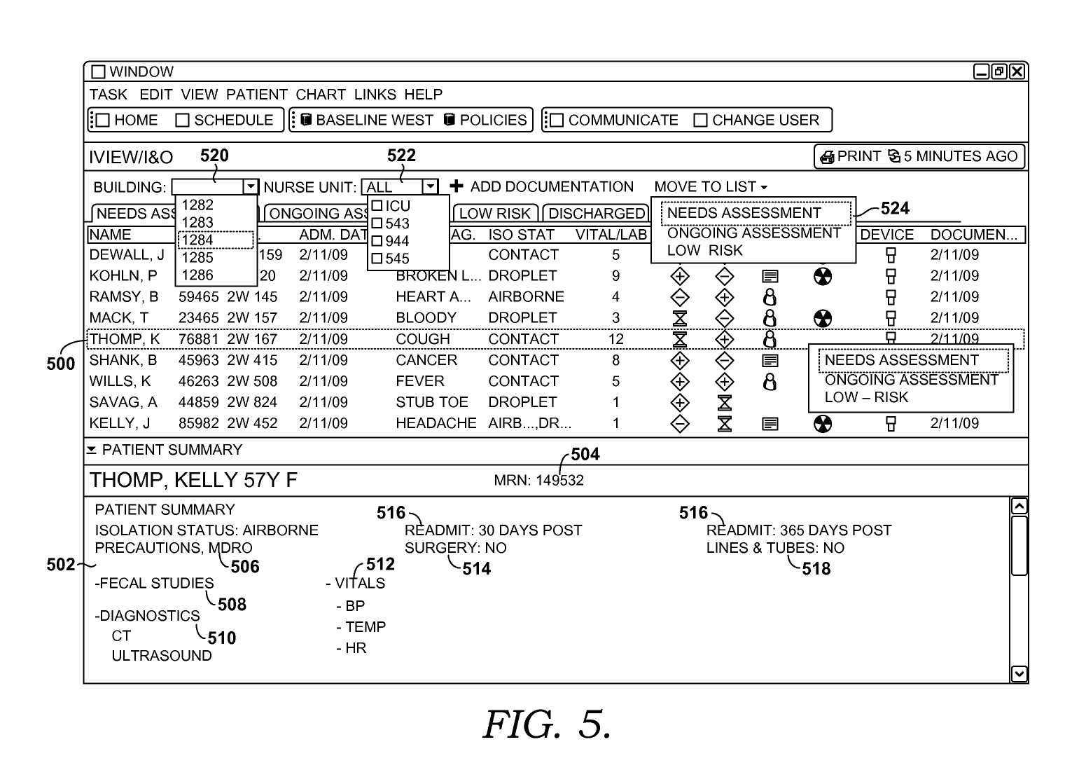

In one embodiment, patient healthcare data is listed for each patient presented to the IP. As shown in FIG. 5, when a patient is selected (shown at 500), healthcare data specific to the selected patient is retrieved and displayed in a viewing area 502. Examples of additional healthcare data that may be presented includes, for example but without limitation, information such as a patient's MRN 504, isolation status 506 (e.g., airborne, droplet, touch, etc.), precautions 506 (e.g., multidrug-resistant organisms (“MDRO”)), fecal studies 508, diagnostics 510 (e.g., ultrasound, computed tomography (“CT”), etc.), vital signs 512, surgical history 514, admission or readmission date 516, lines and intubation 518, and so forth. Other patient healthcare data may alternatively be presented when the IP selects a patient.

A list of patients being shown to the IP may be filtered by the building 520, nurse unit 522, or other location and treating parameter. Once a patient is selected, the IP may move the patient from any IC category to another using dropdown menu 524. Alternatively, additional healthcare data about a patient may be presented in its own GUI window.

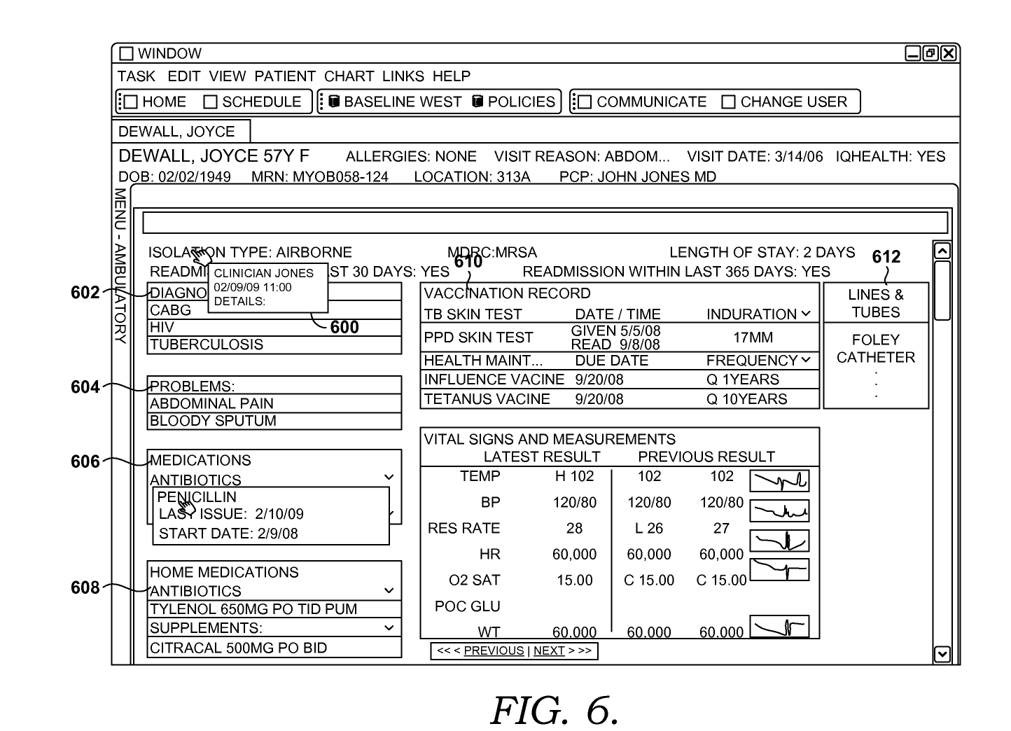

FIG. 6 illustrates an alternative GUI displaying additional patient healthcare data, according to an embodiment of the present invention. In particular, the clinician who ordered an isolation for the patient shown may be shown in window 600. Diagnoses 602, assessed medical problems 604, medications 606, reported home medications and antibiotics 608, vaccination records 610, and particular lines and tubes 612, may also be shown.

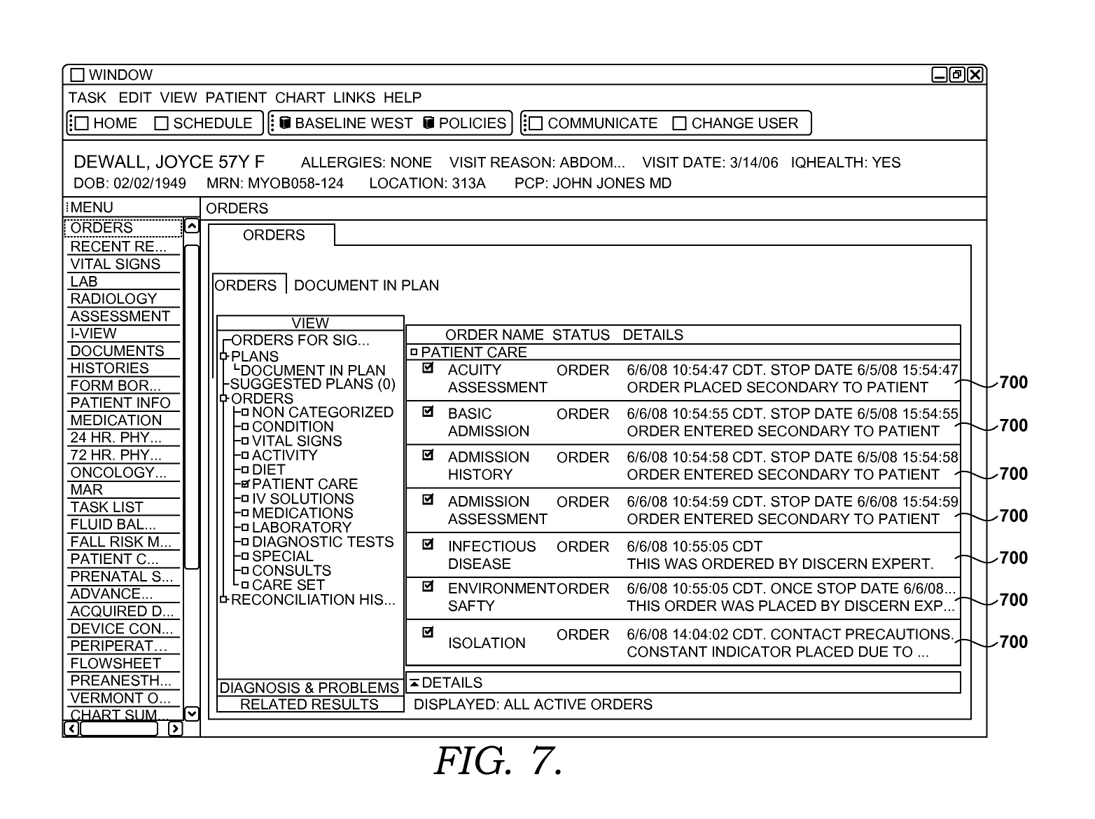

FIG. 7 illustrates a GUI window with a display area for different orders 700 assigned to the patient, according to an embodiment of the present invention. Examples of orders include, without limitation, acuity assessments, admission records, admission assessments, infection disease prescriptions, isolation orders, and so fort.

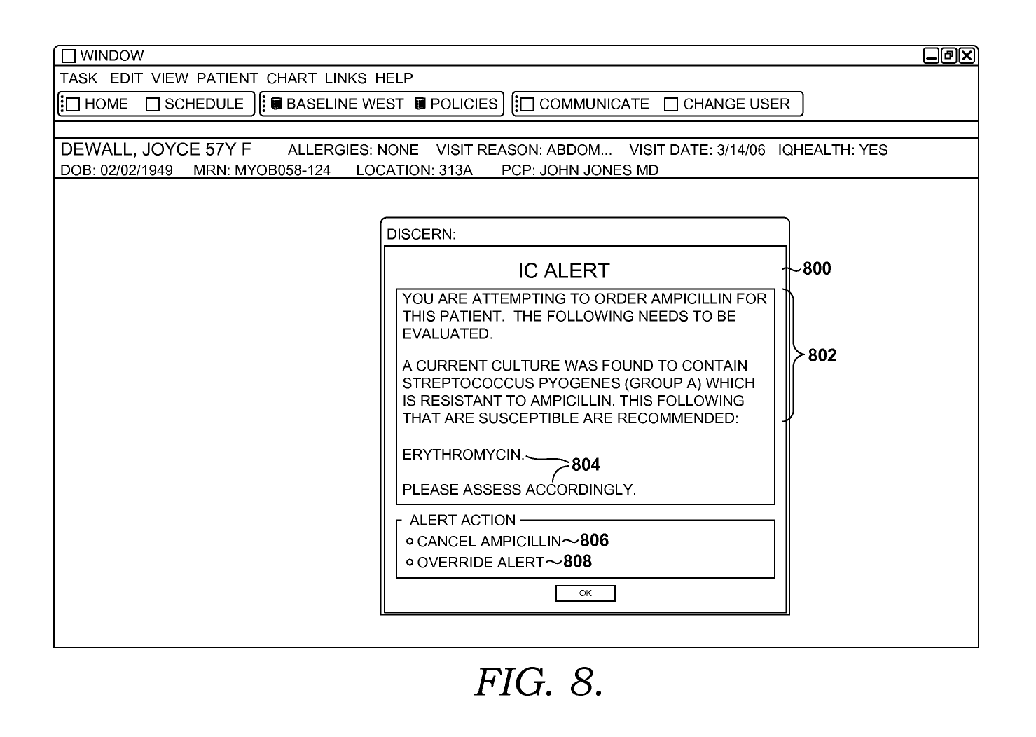

FIG. 8 illustrates an IC alert being presented to an IP, according to an embodiment of the present invention. An IC alert 800 is displayed with an underlying rationale 802 for the alert. Some embodiments may also display a recommendation 804 and/or actions (806 and 808) for the IP to consider. The rationale 802 for the IC alert may be based on the conditions specified by the healthcare facility or a supervising medical organization.

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of this invention. A skilled programmer may develop alternative means for implementing the aforementioned improvements without departing from the scope of the present invention.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims.

The invention claimed is:

1. A method, executed by a server, for performing steps to organize patients of an infection preventionist (“IP”) into a plurality of infection control categories (“IC categories”) and transmit the IC categories to an infection control remote computer (“IC remote computer”), comprising:
analyzing healthcare data associated with the patients of the IP;
applying conditions of triggering events to the healthcare data;
organizing the patients of the IP into the IC categories based on the healthcare data; and
transmitting a list of the patients, organized by the IC categories, to the IC remote computer.

2. The media of claim 1, wherein the conditions of the triggering events are specified by administrators at a healthcare facility.

3. The media of claim 1, wherein the conditions of the triggering events are specified by a medical organization.

4. The media of claim 1, wherein the list is stored in an electronic document that contains hyperlinks to the healthcare data of the patients.

5. The media of claim 4, wherein the electronic document is a hypertext mark-up language (“HTML”) or an extensible mark-up language (“XML”) document.

6. The media of claim 1, further comprising displaying the list, organized according to the IC categories, on the IP remote computer.

7. The media of claim 1, wherein the IC categories comprise a category for one or more patients who need to be assessed by the IP.

8. The media of claim 1, wherein the IC categories comprise a category for one or more patients who need to be monitored in the future.

9. The media of claim 1, wherein the IC categories comprise a category for one or more patients who need to be monitored in the future.

10. One or more computer-storage media having computer-executable instructions embodied thereon for performing steps to initiate an infection control alert (“IC alert”) for a patient of an infection preventionist (“IP”) and transmit the IC alert to an infection control remote computer (“IC remote computer”), comprising:
analyzing healthcare data associated with patients of the IP;
applying conditions of an IC alert to the healthcare data;
determining the healthcare data associated with the patient meets the conditions for the IC alert; and
transmitting a message to the IC remote computer, the message informing of the IC alert.

11. The media of claim 10, wherein the IC alert calls for isolation of the patient.

12. The media of claim 11, wherein the isolation depends on the type of healthcare data used to determine the IC alert.

13. The media of claim 10, wherein the isolation depends on the patient having at least member of a group consisting of:
a surgical history,
an illness,
a diagnosis,
an intubation, and
an inserted line.

14. The media of claim 10, wherein the IC alert includes a rationale for the IC alert.

15. The media of claim 10, wherein the IC alert includes a medical recommendation.

16. A graphical user interface (GUI) stored on one or more computer-readable media and executable by a computing device, said GUI comprising:
a first display area configured for displaying a list of patients organized into different infection control categories (“IC categories”), the IC categories indicating whether an infection preventionist (“IP”) needs to assess or monitor the patients; and
a second display area configured for displaying lines and tubes associated with one of the patients.

17. The media of claim 16, wherein one of the IC categories indicates a group of the patients needs to be assessed by the IP.

18. The media of claim 16, wherein one of the IC categories indicates a group of the patients needs to be monitored further based on a triggering event.

19. The media of claim 16, wherein the second display area indicates clinician who either intubated the patient or inserted a tube in the patient.

20. The media of claim 16, wherein the second display area is displayed within the same GUI window as the first display area.
